(19) United States
(12) Patent Application Publication
(10) Pub. No.: US 2009/0150151 A1
(43) Pub. Date: Jun. 11, 2009

(54) Audio processing apparatus, audio processing system, and audio processing program

(75) Inventors: Yohei Sakuraba, Kanagawa (JP); Yasuhiko Kato, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/313,334

(22) Filed: Nov. 19, 2008

(30) Foreign Application Priority Data
Dec. 5, 2007 (JP) P2007-315216

(51) Int. Cl. G10L 17/00

(52) U.S. Cl. 704/246; 704/E17.001

(57) ABSTRACT

Disclosed herein is an audio processing apparatus for processing a plurality of pieces of audio data of sounds picked up by a plurality of microphones. The apparatus includes: a speaker identification section configured to identify a speaker based on the audio data; a simultaneous speech section identification section configured to, when at least first and second speakers have been identified, identify speech sections during which the first and second speakers have made speeches, and identify a section during which the first and second speakers have made the speeches at the same time as a simultaneous speech section; and an arranging section configured to separate audio data of the first speaker and audio data of the second speaker from the simultaneous speech section, and allow the audio data of the first speaker and the audio data of the second speaker to be outputted at mutually different timings.

### CROSS REFERENCES TO RELATED APPLICATIONS

The present invention contains subject matter related to Japanese Patent Application JP 2007-315216 filed in the Japan Patent Office on Dec. 5, 2007, the entire contents of which being incorporated herein by reference.

### BACKGROUND OF THE INVENTION

1. Field of the Invention

An embodiment of the present invention relates to an audio processing apparatus, an audio processing system, and an audio processing program which are suitable for use when processing sounds picked up in an environment such as a conference room where a plurality of speakers make speeches, for example.

2. Description of the Related Art

At present, video conferencing systems are used as demanded which are placed in separate conference rooms remote from each other (hereinafter referred to as first and second conference rooms as appropriate) in order to facilitate smooth progress of a conference held with its participants in the first and second conference rooms, for example. The video conferencing systems enable speakers in the first and second conference rooms to talk to one another, and make it possible to show a video of a speaker in each conference room to the conference participants in the other conference room. The video conferencing systems include a plurality of video/audio processing apparatuses that are capable of showing a video of each of the conference rooms to the conference participants in the other of the conference rooms, and outputting an audio of a speech made by a speaker. It is assumed here that the video/audio processing apparatuses are placed in each of the first and second conference rooms.

Each of the video/audio processing apparatuses includes a microphone for picking up sounds made during the conference, a camera for filming speakers, a signal processing section for subjecting a voice of the speaker picked up by the microphone to a specified process, a display section for displaying a video showing the speaker who makes a speech in the other conference room, and a loudspeaker for outputting an audio of the speech made by the speaker.

The video/audio processing apparatuses placed in the separate conference rooms are connected to each other via a communication channel. The video/audio processing apparatuses exchange video/audio data recorded therein with each other so that the video showing each of the conference rooms is displayed in the other of the conference rooms and the audio of the speech made by a speaker in each of the conference rooms is outputted in the other of the conference rooms. Hereinafter, the term “independent speech” refers to a speech made by a single speaker at a time, whereas the term “simultaneous speech” refers to speeches made by a plurality of speakers at a time.

Japanese Patent Laid-Open No. 2004-109779 describes an audio processing apparatus that performs a process for preventing a sound picked up by a microphone from acting as a disturbance.

### SUMMARY OF THE INVENTION

Here, a plurality of microphones may be placed in the first conference room in order to pick up speeches made by a plurality of speakers in the first conference room. If the simultaneous speech occurs in this case, sounds picked up by one microphone may include speeches made by a plurality of speakers. The sounds picked up by the plurality of microphones are mixed by the signal processing section in the video/audio processing apparatus to obtain an audio of the mixed sounds, and the audio of the mixed sounds is transmitted to the video/audio processing apparatus placed in the second conference room.

The video/audio processing apparatus placed in the second conference room plays the received audio of the mixed sounds. However, because the audio played involves the simultaneous speech, the conference participants in the second conference room may not be able to identify each speaker in the first conference room. Moreover, in the case where the simultaneous speech has occurred, it is sometimes difficult to catch and comprehend the speeches.

As a known solution to the problem of the simultaneous speech, the video/audio processing apparatus placed in the first conference room picks up the speeches in stereo, while the video/audio processing apparatus placed in the second conference room plays the audio of the speeches in stereo. Stereo playback facilitates auditory lateralization even in the case of the simultaneous speech, and makes it easier to perceive relative locations of the speakers. This enables the conference participants in the second conference room to catch and comprehend the speeches more easily. However, because the simultaneous speech means that different speakers make different speeches at the same time, it is still hard to catch and comprehend the speeches when the audio of the speeches is played back.

An embodiment of the present invention addresses the above-identified, and other problems associated with existing methods and apparatuses, and makes it possible to play back speeches made by individual speakers clearly even when the simultaneous speech has occurred.

According to one embodiment of the present invention, there is provided an audio processing apparatus for processing a plurality of pieces of audio data of sounds picked up by a plurality of microphones, the apparatus including: a speaker identification section configured to identify a speaker based on the plurality of pieces of audio data; a simultaneous speech section identification section configured to, when at least first and second speakers have been identified by the speaker identification section, identify speech sections during which the identified first and second speakers have made speeches, and identify a section during which the first and second speakers have made the speeches at the same time as a simultaneous speech section; and an arranging section configured to separate audio data of the first speaker and audio data of the second speaker from the simultaneous speech section identified by the simultaneous speech section identification section, and allow the audio data of the first speaker and the audio data of the second speaker to be outputted at mutually different timings.

According to another embodiment of the present invention, there is provided an audio processing system for processing a plurality of pieces of audio data of sounds picked up by a plurality of microphones, the system including: a speaker identification section configured to identify a speaker based on the plurality of pieces of audio data; a simultaneous speech section identification section configured to, when at least first and second speakers have been identified by the speaker identification section, identify speech sections during which the identified first and second speakers have made speeches, and identify a section during which the first and second speakers have made the speeches at the same time as a simultaneous speech section; and an arranging section configured to separate audio data of the first speaker and audio data of the second speaker from the simultaneous speech section identified by the simultaneous speech section identification section, and allow the audio data of the first speaker and the audio data of the second speaker to be outputted at mutually different timings.

According to yet another embodiment of the present invention, there is provided an audio processing program for processing a plurality of pieces of audio data of sounds picked up by a plurality of microphones, the program causing a computer to perform: a speaker identification process of identifying a speaker based on the plurality of pieces of audio data; a simultaneous speech section identification process of, when at least first and second speakers have been identified by the speaker identification process, identifying speech sections during which the identified first and second speakers have made speeches, and identifying a section during which the first and second speakers have made the speeches at the same time as a simultaneous speech section; and an arranging process of separating audio data of the first speaker and audio data of the second speaker from the simultaneous speech section identified by the simultaneous speech section identification process, and allowing the audio data of the first speaker and the audio data of the second speaker to be outputted at mutually different timings.

According to yet another embodiment of the present invention, when a plurality of pieces of audio data of sounds picked up by a plurality of microphones are processed, a speaker is identified based on the plurality of pieces of audio data. Then, when at least first and second speakers have been identified, speech sections during which the identified first and second speakers have made speeches are identified, and a section during which the first and second speakers have made the speeches at the same time is identified as a simultaneous speech section. Then, audio data of the first speaker and audio data of the second speaker are separated from the identified simultaneous speech section, and the audio data of the first speaker and the audio data of the second speaker are outputted at mutually different timings.

According to the above-described embodiments, even if a plurality of speakers make speeches at the same time, audios of voices of the individual speakers are outputted at mutually different timings, so that the voices of the individual speakers can be reproduced clearly.

According to an embodiment of the present invention, even if a plurality of speakers make speeches at the same time, the voices of the individual speakers can be reproduced clearly. For example, suppose that a conference is carried out with some of its participants in one conference room and the others participants in another conference room remote from the former conference room. In this case, even if simultaneous speech occurs in one of the conference rooms, the multiple speeches can be reproduced as independent speeches in the other conference room. Therefore, even if the simultaneous speech occurs, the conference participants can hear the speech of each individual speaker more clearly.

### BRIEF DESCRIPTION OF THE DRAWINGS

FIG. 1 is a block diagram illustrating an exemplary internal structure of a video conferencing system according to one embodiment of the present invention;

FIG. 2 is a block diagram illustrating an exemplary internal structure of a signal processing section according to one embodiment of the present invention;

FIG. 3 is a flowchart illustrating an exemplary speech rate conversion process according to one embodiment of the present invention; and

FIGS. 4A, 4B, and 4C are diagrams illustrating examples of reproduced sounds that have been subjected to an audio shifting process, a speech rate conversion process, and/or a silent section compression process according to one embodiment of the present invention.

### DETAILED DESCRIPTION OF THE PREFERRED EMBODIMENT

Hereinafter, one embodiment of the present invention will be described with reference to the accompanying drawings. As a video/audio processing system that processes video data and audio data according to the present embodiment, a video conferencing system 10 that enables real-time transmission and reception of the video data and the audio data between remote locations will be described.

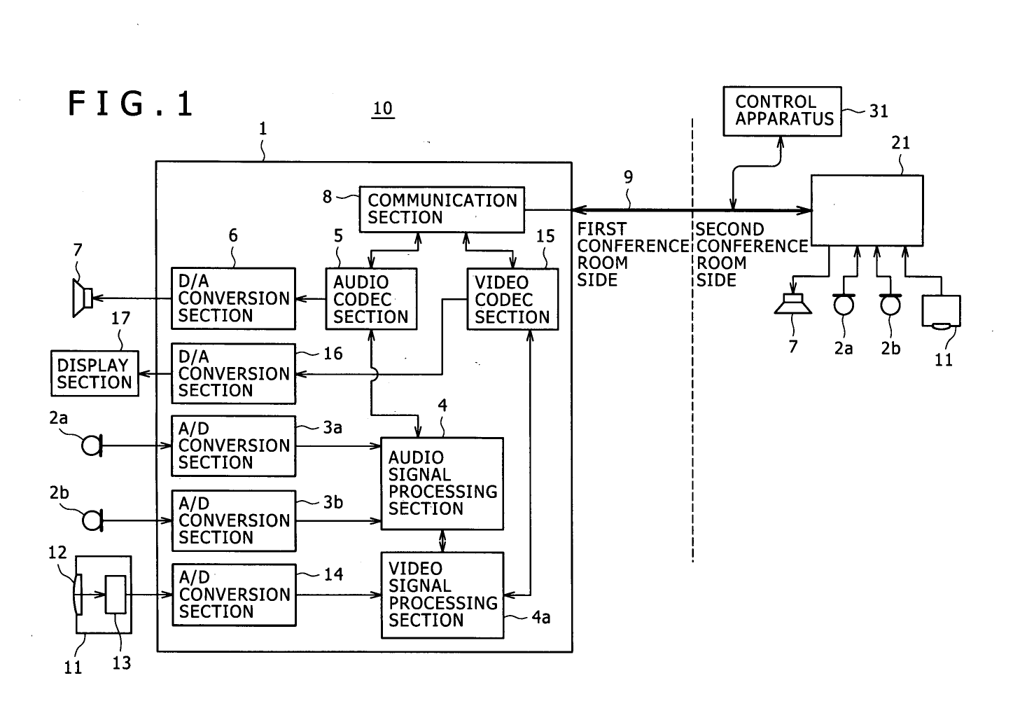

FIG. 1 is a block diagram illustrating an exemplary structure of the video conferencing system 10.

In first and second conference rooms, which are remote from each other, video/audio processing apparatuses 1 and 21 capable of processing the video data and the audio data are placed, respectively. The video/audio processing apparatuses 1 and 21 are connected to each other via a digital communication channel 9, such as an Ethernet (registered trademark) channel, which is capable of transferring digital data. A control apparatus 31 for controlling timing of data transfer and so on exercises centralized control over the video/audio processing apparatuses 1 and 21 via the communication channel 9.

An exemplary internal structure of the video/audio processing apparatus 1 will now be described below. The video/audio processing apparatus 21 has significantly the same structure as the video/audio processing apparatus 1. Therefore, illustration of internal blocks of the video/audio processing apparatus 21 and detailed descriptions thereof are omitted.

The video/audio processing apparatus 1 includes: microphones 2a and 2b for picking up voices of speakers to generate analog audio data of the voices; A/D (Analog/Digital) conversion sections 3a and 3b for amplifying the analog audio data supplied from the microphones 2a and 2b, respectively, using an amplifier (not shown) and converting the amplified analog audio data into digital audio data; and an audio signal processing section 4 for subjecting the digital audio data supplied from the A/D conversion sections 3a and 3b to specified processes.

The microphones 2a and 2b are arranged in such a manner that the voices of the individual speakers can be picked up separately. This arrangement is accomplished by spacing the neighboring microphones properly or employing directional microphones. Each of the microphones 2a and 2b picks up the voices of the speakers in the first conference room, and is also capable of picking up sounds outputted from a loudspeaker 7 via a space so as to be superimposed upon the voices of the speakers. The analog/digital conversion sections 3a and 3b convert the analog audio data supplied from the microphones 2a and 2b, respectively, into the digital audio data, e.g., PCM (Pulse-Code Modulation) audio data (48 kHz/16-bit). The resulting digital audio data is supplied to the signal processing section 4 on a sample-by-sample basis.

The signal processing section 4 is formed by a DSP (Digital Signal Processor). Details of processes performed by the signal processing section 4 will be described later.

The video/audio processing apparatus 1 further includes an audio codec section 5 for encoding the digital audio data supplied from the signal processing section 4 into a code that is standardized for communication in the video conferencing system 10. The audio codec section 5 also has a function of decoding encoded digital audio data supplied from the video/audio processing apparatus 21 via a communication section 8, which is a communication interface. The video/audio processing apparatus 1 further includes: a D/A (Digital/Analog) conversion section 6 for converting the digital audio data supplied from the audio codec section 5 into analog audio data; and the loudspeaker 7 for amplifying the analog audio data supplied from the digital/analog conversion section 6 using an amplifier (not shown) and outputting the sounds based on the amplified analog audio data.

The video/audio processing apparatus 1 further includes: a camera 11 for filming the speaker to generate analog video data of the speaker; and an analog/digital conversion section 14 for converting the analog video data supplied from the camera 11 into digital video data. The resulting digital video data obtained by the conversion by the analog/digital conversion section 14 is supplied to a video signal processing section 4a and subjected to a specified process therein.

The video/audio processing apparatus 1 further includes: a video codec section 15 for encoding the digital video data subjected to the specified process in the signal processing section 4a; a digital/analog conversion section 16 for converting the digital video data supplied from the video codec section 15 into analog video data; and a display section 17 for amplifying the analog video data supplied from the digital/analog conversion section 16 using an amplifier (not shown) and displaying a video based on the amplified analog video data.

The communication section 8 controls communication of the digital video/audio data in relation to the control apparatus 31 and the video/audio processing apparatus 21, which are communication partner apparatuses. The communication section 8 segments the digital audio data encoded by the audio codec section 5 in accordance with a predetermined encoding system (e.g., an MPEG (Moving Picture Experts Group)-4 system, an AAC (Advanced Audio Coding) system, or a G.728 algorithm) and the digital video data encoded by the video codec section 15 in accordance with a predetermined system into packets in accordance with a predetermined protocol. Then, the communication section 8 transfers the packets to the video/audio processing apparatus 21 via the communication channel 9.

In addition, the video/audio processing apparatus 1 receives packets of digital video/audio data from the audio processing apparatus 21. The communication section 8 combines the received packets, and the audio codec section 5 and the video codec section 15 decode the combined packets. The digital audio data decoded is subjected to the specified processes in the signal processing section 4, the resulting digital audio data is passed through the D/A conversion section 6 and amplified by the amplifier (not shown), and the corresponding sounds are outputted from the loudspeaker 7. Similarly, the digital video data decoded is subjected to the specified process in the signal processing section 4, the resulting digital video data is passed through the D/A conversion section 16 and amplified by the amplifier (not shown), and the corresponding video is displayed by the display section 17.

The display section 17 displays videos showing conference participants in the first and second conference rooms with split screen display. Accordingly, a conference can be carried out with the conference participants in the first and second conference rooms remote from each other, without any of the conference participants being troubled by a distance between the two conference rooms.

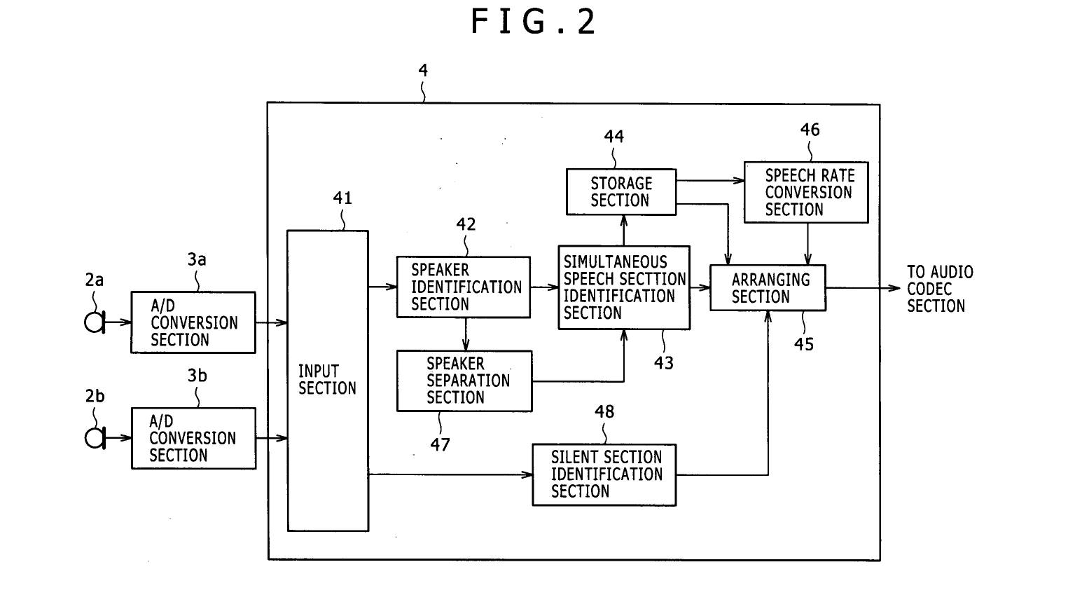

Next, an exemplary internal structure of the signal processing section 4 will now be described below with reference to a block diagram of FIG. 2. The signal processing section 4 according to the present embodiment subjects the digital audio data to the specified processes. Therefore, descriptions concerning functional blocks for processing the digital video data are omitted.

The signal processing section 4 includes an input section 41 for adding, to the digital audio data inputted thereto via the analog/digital conversion sections 3a and 3b, information about times at which the corresponding sounds were picked up by the microphones 2a and 2b. The signal processing section 4 further includes a speaker identification section 42 for identifying a speaker who has made a speech based on the combined digital audio data. The signal processing section 4 further includes: a simultaneous speech section identification section 43 for identifying a section during which a plurality of speakers made speeches at the same time as a simultaneous speech section; a storage section 44 for temporarily storing digital audio data generated during the simultaneous speech section; and an arranging section 45 for arranging pieces of digital audio data in order of playback.

The signal processing section 4 further includes a speech rate conversion section 46 for converting a speech rate, i.e., a rate at which the digital audio data generated during the simultaneous speech section is played back, based on the information about the time added to the digital audio data read from the storage section 44. The signal processing section 4 further includes: a speaker separation section 47 for separating voices of a plurality of speakers picked up by a single microphone into voices of the individual speakers; and a silent section identification section 48 for identifying a section during which a sound level is below a predetermined threshold as a silent section, i.e., a section during which no person uttered a voice.

The input section 41 adds, to each piece of digital audio data, the information about the time at which the corresponding sound was picked up. Then, the input section 41 combines pieces of digital audio data generated based on the sounds picked up by the plurality of microphones at the same time.

In the case where the sound level exceeds the predetermined threshold, the speaker identification section 42 identifies each speaker. In the case where the microphones used have a high directivity, identifiers of the microphones correspond to individual speakers uniquely. Accordingly, the speaker identification section 42 is capable of identifying each speaker based on the identifier of the microphone whose sound level exceeds the predetermined threshold.

In the case where at least two speakers (hereinafter referred to as first and second speakers) have been identified by the speaker identification section 42, the simultaneous speech section identification section 43 identifies, based on the information about the time added to each piece of digital audio data, speech sections during which the identified first and second speakers made speeches. Then, the simultaneous speech section identification section 43 identifies a section during which the first and second speakers made the speeches at the same time as the simultaneous speech section. Because a plurality of speakers made speeches at the same time during the simultaneous speech section, it is important to identify who made the respective speeches.

The storage section 44 has a plurality of storage areas segmented logically. When the simultaneous speech has occurred, the storage section 44 temporarily stores the pieces of digital audio data of the individual speakers as identified by the speaker identification section 42 separately. Each of the storage areas is variable, and the size of each of the storage areas can be set appropriately depending on the number of speakers and periods of time during which their voices were picked up. The digital audio data stored in the storage section 44 is data that includes the speeches made by the speakers during the simultaneous speech section. The storage section 44 has a data structure according to a FIFO (First In First Out) queue. Thus, digital audio data that was written to the storage section 44 first is read from the storage section 44 first. In the present embodiment, it is assumed that the maximum amount of data that can be stored in the storage section 44 for each microphone corresponds to 20 seconds of sound pick-up time, and that the storage section 44 is capable of temporarily storing the digital audio data of one speaker.

The arranging section 45 separates, from the digital audio data corresponding to the simultaneous speech section identified by the simultaneous speech section identification section 43, the digital audio data of the first speaker and the digital audio data of the second speaker, and allows the digital audio data of the first speaker and the digital audio data of the second speaker to be outputted at mutually different timings. Of the digital audio data corresponding to the simultaneous speech section identified by the simultaneous speech section identification section 43, the arranging section 45 outputs the digital audio data of the first speaker significantly on a real-time basis, and subjects the digital audio data of the second speaker to speech rate conversion to shorten the audio of the digital audio data of the second speaker along a time axis. Then, the arranging section 45 arranges the pieces of digital audio data of the first and second speakers according to the identifiers assigned to the microphones (i.e., according to the speakers), for example, in an order in which the speakers made the speeches. Suppose here that the first speaker made the speech toward the microphone 2a first and then, while the first speaker was making the speech, the second speaker made the speech toward the microphone 2b, resulting in the simultaneous speech. In this case, the digital audio data of the first speaker will be played back first, before the digital audio data of the second speaker is played back. Thus, the digital audio data generated by the microphone 2b is stored in the storage section 44 temporarily. Then, in accordance with the order in which the audios should be played back, the arranging section 45 arranges the digital audio data generated by the microphone 2a and the digital audio data generated by the microphone 2b and read from the storage section 44 in this order. The pieces of digital audio data as arranged are supplied to the audio codec section 5.

The speech rate conversion section 46 performs a predetermined speech rate conversion process on the digital audio data temporarily stored in the storage section 45. The speech rate conversion process performed by the speech rate conversion section 46 uses PICOLA (Pointer Interval Controlled Overlap and Add) or the like, for example. There have been proposed various other techniques for the speech rate conversion process, such as TDHS (Time Domain Harmonic Scaling), and such other known techniques may be used for the speech rate conversion process. As a result of the speech rate conversion process, a playback rate at which the resultant digital audio data is played back using the loudspeaker 7 or the like becomes 120%, for example, on the assumption that a sound pick-up rate at which the speeches are picked up using the microphones 2a and 2b is expressed as 100%.

The speaker separation section 47 is capable of separating a voice of only a speaker picked up by a plurality of microphones based on the speaker identified by the speaker identification section 42 from the plurality of pieces of digital audio data combined at the same time. The processing of the speaker separation section 47 is performed when one piece of digital audio data contains voices of a plurality of speakers due to use of omnidirectional microphones or the number of speakers being larger than the number of microphones. Any technique may be adopted for a sound source separation process performed by the speaker separation section 47. Examples of such techniques as proposed include: “delay and sum beam forming” that identifies the speaker using the omnidirectional microphone; a microphone array process, such as an adaptive beamformer, which is excellent in directivity for identifying the speaker; and independent component analysis, which identifies the speaker based on a power correlation between a plurality of microphones.

The silent section identification section 48 identifies the section during which the sound level is equal to or below the predetermined threshold as the silent section. Information about the identified silent section is supplied to the arranging section 45.

The arranging section 45 compresses a part of the silent section identified by the silent section identification section 48. When compressing a part of the silent section, the arranging section 45 identifies that part of the silent section based on information about the arranged digital audio data, and compresses the identified part of the silent section.

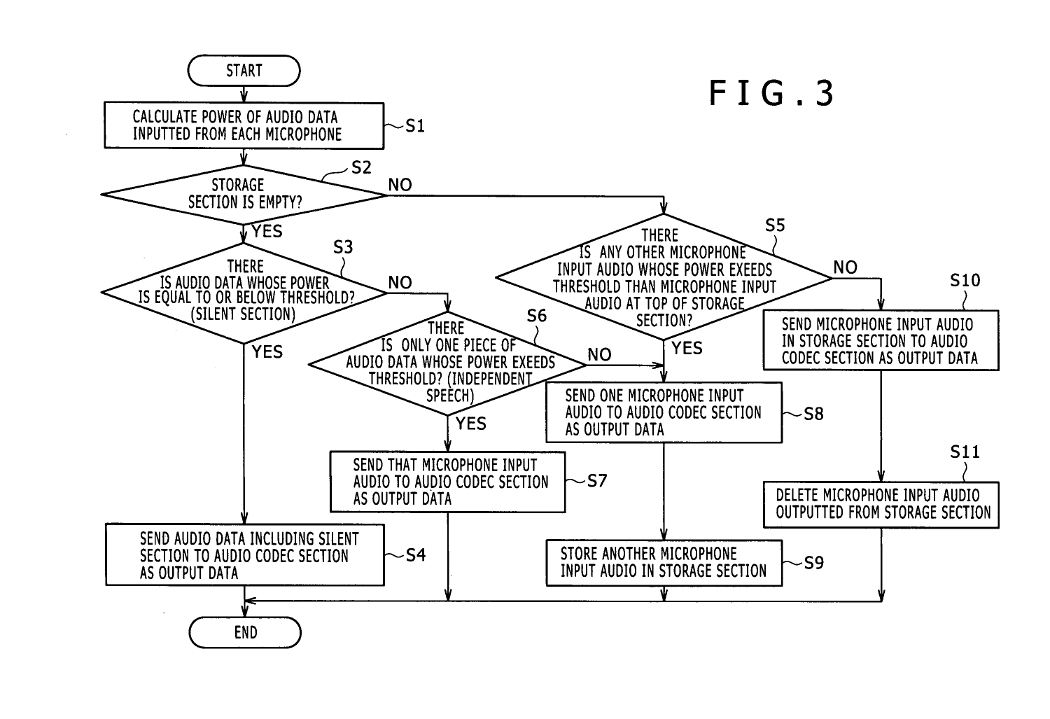

Next, an exemplary speech rate conversion process performed by the signal processing section 4 will now be described below with reference to a flowchart of FIG. 3.

First, the signal processing section 4 calculates power of the digital audio data (hereinafter simply referred to as a “microphone input audio” as appropriate) inputted thereto from the microphones 2a and 2b via the analog/digital conversion sections 3a and 3b (step S1). Then, the arranging section 45 determines whether the storage section 44 is empty (step S2).

If the storage section 44 is empty, the signal processing section 4 determines whether the power of the microphone input audio exceeds the threshold (step S3). Specifically, if the power of the microphone input audio does not exceed the threshold, it can be determined that the microphone input audio corresponds to the silent section during which no person made a speech.

If it is determined at step S3 that the silent section exists, the signal processing section 4 sends the digital audio data including the silent section to the audio codec section 5 as output data (step S4), and ends this procedure.

If it is determined at step S3 that the silent section does not exist, the speaker identification section 42 determines whether the number of microphones the power of whose microphone input audio exceeds the threshold is one (step S6).

If the number of microphones the power of whose microphone input audio exceeds the threshold is one, that means that an independent speech has occurred, and therefore, the microphone input audio whose power exceeds the threshold is outputted as the output data to the audio codec section 5 via the simultaneous speech section identification section 43 and the arranging section 45 (step S7).

Returning to the explanation of the process of step S2, if it is determined at step S2 that the storage section 44 is not empty, it is determined whether there is any other microphone input audio whose power exceeds the threshold than a microphone input audio that was the first to have been inputted to the storage section 44, which has the FIFO queue structure (step S5).

If it is determined at step S6 that the number of microphone input audios whose power exceeds the threshold is more than one, the simultaneous speech section identification section 43 determines that the simultaneous speech has occurred. Then, when it is determined at step S5 that there is any other microphone input audio whose power exceeds the threshold than the microphone input audio that was the first to have been inputted to the storage section 44, the simultaneous speech section identification section 43 determines that the simultaneous speech is still continuing. Accordingly, after the processes of steps S5 and S6, the simultaneous speech section identification section 43 identifies the simultaneous speech section. Thus, the simultaneous speech section identification section 43 sends one of the microphone input audios to the arranging section 45 so as to be sent then to the audio codec section 5 as the output data (step S8). At the same time, the simultaneous speech section identification section 43 stores the other microphone input audio in the storage section 44 (step S9).

Meanwhile, if it is determined at step S5 that there is not any other microphone whose power exceeds the threshold than the microphone corresponding to the data at the top of the storage section 44, there is a need to perform the speech rate conversion process to adjust timing that has been delayed relative to an actual time. Thus, the speech rate conversion section 46 subjects the microphone input audio read from the storage section 44 to the speech rate conversion to compress the microphone input audio, and sends the compressed microphone input audio to the audio codec section 5 (step S10). At the same time, the speech rate conversion section 46 deletes the microphone input audio outputted from the storage section 44 (step S11).

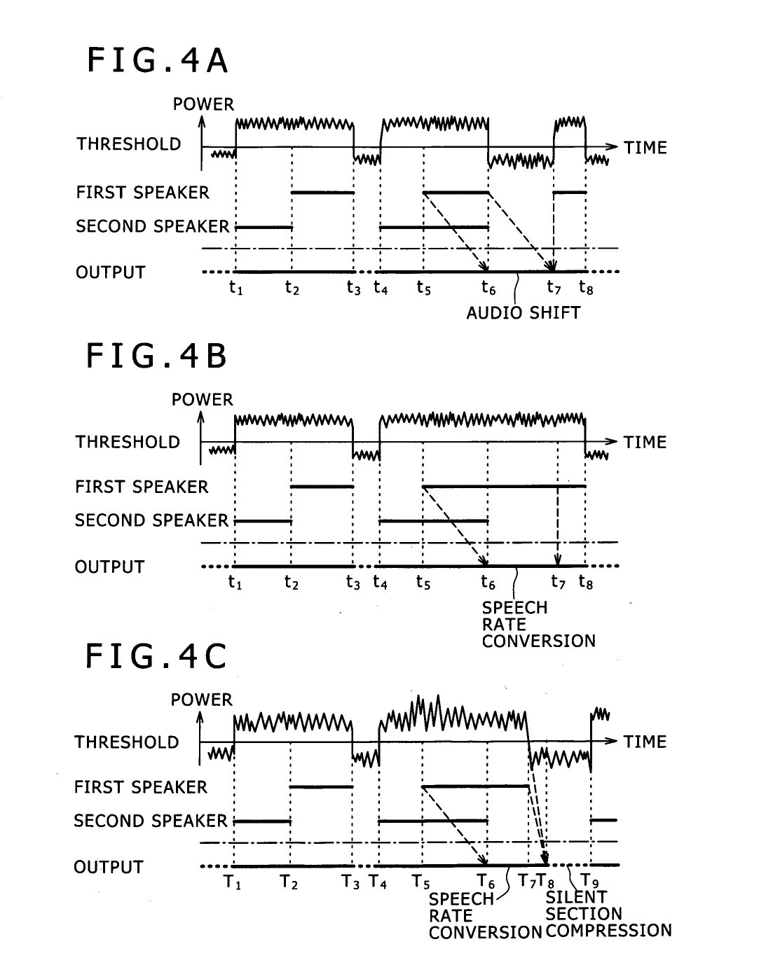

Next, examples of reproduced sounds outputted via the signal processing section 4 will now be described below with reference to FIGS. 4A, 4B, and 4C.

FIG. 4A illustrates an exemplary operation when an audio shifting process is performed.

If the power of the sound picked up by the microphone exceeds the predetermined threshold, that means that any speaker is making a speech. When the first speaker makes a speech during a section from time t₂ to time t₃ and the second speaker makes a speech during a section from time t₁ to time t₂, an output audio is outputted from the loudspeaker 7 or the like continuously during a section from time t₁ to time t₃. Hereinafter, the digital audio data of the first speaker identified by the speaker identification section 42 or separated by the speaker separation section 47 will be referred to as “first digital audio data,” whereas the digital audio data of the second speaker identified by the speaker identification section 42 or separated by the speaker separation section 47 will be referred to as “second digital audio data.”

Meanwhile, when the first speaker makes a speech during a section from time t₅ to time t₆ and the second speaker makes a speech during a section time t₄ to time t₆, the simultaneous speech occurs during the section from time t₅ to time t₆. In the signal processing section 4 according to the present embodiment, the voice of the second speaker (i.e., the second digital audio data), who made the speech first, is outputted first. The first digital audio data during the section from time t₅ to time t₆ is temporarily saved in the storage section 44. Then, when the second speaker has completed the speech (at time t₆), the first digital audio data is read from the storage section 44 and subjected to audio shifting so that the audio during the section from time t₅ to time t₆ will be played back during a section from time t₆ to time t₇. During a section from time t₇ to time t₈, an audio is outputted at a normal speech rate without the speech rate conversion being performed thereon. The arranging section 45 arranges the digital audio data in order so that the second digital audio data will be played back next to the first digital audio data. The arranged digital audio data is supplied, via the audio codec section 5, the communication channel 9, or the like, to each of the loudspeakers 7 placed in the first and second conference rooms, and outputted therefrom in sound form.

FIG. 4B illustrates an exemplary operation when the speech rate conversion process is performed.

In FIG. 4B, as well as in FIG. 4A, when the first speaker makes a speech during a section from time t₂ to time t₃ and the second speaker makes a speech during a section from time t₁ to time t₂, the output audio is outputted from the loudspeaker 7 or the like continuously during a section from time t₁ to time t₃.

Meanwhile, when the first speaker makes a speech during a section from time t₅ to time t₈ and the second speaker makes a speech during a section from time t₄ to time t₆, the simultaneous speech occurs during a section from time t₅ to time t₆. In the signal processing section 4 according to the present embodiment, the voice of the second speaker (i.e., the second digital audio data), who made the speech first, is outputted first. The first digital audio data during the section from time t₅ to time t₆ is temporarily saved in the storage section 44. Then, when the second speaker has completed the speech (at time t₆), the first digital audio data is read from the storage section 44, and the speech rate conversion section 46 subjects the first digital audio data to the speech rate conversion so that an audio during a section from time t₅ to time t₇ will be played back during a section from time t₆ to time t₇. During a section from time t₇ to time t₈, an audio is outputted at the normal speech rate without the speech rate conversion being performed thereon. Then, the arranging section 45 arranges the digital audio data in order so that the second digital audio data will be played back next to the first digital audio data. The arranged digital audio data is supplied, via the audio codec section 5, the communication channel 9, or the like, to each of the loudspeakers 7 placed in the first and second conference rooms, and outputted therefrom in sound form.

FIG. 4C illustrates an exemplary operation when the speech rate conversion process and the silent section compression process are performed.

In FIG. 4C, as well as in FIG. 4A, when the first speaker makes a speech during a section from time t₂ to time t₃ and the second speaker makes a speech during a section from time t₁ to time t₂, the output audio is outputted from the loudspeaker 7 or the like continuously during a section from time t₁ to time t₃.

Meanwhile, when the first speaker makes a speech during a section from time t₅ to time t₇ and the second speaker makes a speech during a section from time t₄ to time t₆, the simultaneous speech occurs during a section from time t₅ to time t₆. In the signal processing section 4 according to the present embodiment, the voice of the second speaker (i.e., the second digital audio data), who made the speech first, is outputted first. The first digital audio data during the section from time t₅ to t₇ is temporarily saved in the storage section 44. Then, when the second speaker has completed the speech (at time t₆), the first digital audio data is read from the storage section 44, and the speech rate conversion section 46 subjects the first digital audio data to the speech rate conversion so that an audio during the section from time t₅ to time t₇ will be played back during a section from time t₆ to time t₈. Then, because the second speaker starts a speech at time t₉, a silent section from time t₇ to time t₉ is compressed. Accordingly, a section that starts with time t₉, at which the second speaker starts the speech, an audio is outputted at the normal speech rate (i.e., the playback rate is equal to the sound pick-up rate) without the speech rate conversion being performed thereon.

The signal processing section 4 according to the present embodiment as described above separates the voices of the individual speakers from the digital audio data obtained by the plurality of microphones, i.e., the microphones 2a and 2b, picking up the sounds, and playing the audios of the voices of the individual speakers at mutually different times. Each microphone has directivity, and therefore, the voices of the individual speakers can be picked up separately. Therefore, in the case where it has been determined that the simultaneous speech has occurred, based on the digital audio data generated by the microphones by picking up the sounds, the audio shifting process of rearranging the digital audio data within the simultaneous speech section is performed so that the voices of different speakers will be played back at mutually different times according to a specified order of priority. As a result of the audio shifting process, the voices of the individual speakers as played back will be heard as if the individual speakers had made independent speeches. Therefore, the participants in the conference or the like will be able to hear the speeches clearly. Thus, in contrast to a known case where the sounds inputted via the plurality of microphones are simply combined to reproduce the combined sounds, the participants in the conference or the like are able to easily recognize who is making the individual speech.

The signal processing section 4 according to the present embodiment as described above has been described on the assumption that two microphones (i.e., the microphones 2a and 2b) pick up the voices of different speakers individually, and that each of the two microphones picks up an independent speech. Note, however, that in the case where more than two microphones are used or where the voice of the same speaker is picked up by a plurality of microphones also, it is possible to separate the speeches of the individual speakers by performing the sound source separation process, and identify the simultaneous speech section, and then perform the speech rate conversion process and the silent section compression process in a similar manner.

Even in the case where the voices of a plurality of speakers are picked up by one microphone, the signal processing section 4 according to the present embodiment as described above is capable of separating the voices of the speakers during the simultaneous speech section individually and performing the speech rate conversion process. Even if, as a result of the speech rate conversion process, the audio of the speech is played back approximately 20% faster than the normal speech rate, for example, the participants in the conference or the like will be able to understand the speech without a significant problem.

The signal processing section 4 according to the present embodiment as described above is capable of accomplishing timing adjustment with respect to a difference in time between when the speech is actually made and when the speech is reproduced as caused by the audio shifting process, by performing the speech rate conversion process and the silent section compression process. Note that the silent section compression process does not affect the speech. Thus, in the audio played back, the speeches during the simultaneous speech section can be heard clearly as if they were independent speeches.

Also note that the signal processing section 4 according to the present embodiment as described above is capable of separating the voices of the individual speakers from digital audio data supplied from the video/audio processing apparatus 21 in which voices of a plurality of speakers are combined. Also note that, even in the case where the digital audio data is supplied from a plurality of video/audio processing apparatuses 21 placed in a plurality of conference rooms, the signal processing section 4 according to the present embodiment as described above is capable of separating voices of individual speakers from the supplied digital audio data. Therefore, even if the digital audio data is supplied from a plurality of conference rooms at the same time, resulting in the simultaneous speech, the speeches of the individual speakers can be heard clearly as if the speakers had made speeches one after another in the same conference room.

Note that the series of processes in the above-described embodiment may be implemented in either hardware or software. In the case where the series of processes is implemented in software, a program that constitutes desired software is installed into a computer that has a dedicated hardware configuration or, for example, a general-purpose personal computer that, when various programs are installed thereon, becomes capable of performing various functions, so that the computer or the general-purpose personal computer can execute the program.

Also note that a storage medium on which a program code of software that implements the functions of the above-described embodiment is recorded may be supplied to a system or an apparatus so that a computer (or a control device such as a CPU (Central Processing Unit)) in the system or the apparatus can read and execute the program code stored in the storage medium. In this manner also, the functions of the present embodiment can be accomplished.

Examples of the storage medium that can be used in that case to supply the program code to the system or the apparatus include: a floppy disk, a hard disk, an optical disc, a magneto-optical disk, a CD-ROM (Compact Disc-Read Only Memory), a CD-R (Compact Disc-Recordable), a magnetic tape, a nonvolatile memory card, and a ROM (Read Only Memory).

The functions of the above-described embodiment may be accomplished by the computer reading and executing the program code. Alternatively, an OS (Operating System) or the like that runs on the computer may perform a part or whole of the processing based on an instruction in the program code in order to accomplish the functions of the above-described embodiment.

Note that the steps implemented by the program forming the software and described in the present specification may naturally be performed chronologically in order of description but need not be performed chronologically. Some steps may be performed in parallel or independently of one another.

Also note that the present invention is not limited to the above-described embodiment. It should be understood by those skilled in the art that various modifications, combinations, sub-combinations and alterations may occur depending on design requirements and other factors insofar as they are within the scope of the appended claims or the equivalents thereof. For example, while the video/audio processing apparatuses 1 and 21 are controlled by the control apparatus 31 in the above-described embodiment, it may be so arranged that the video/audio processing apparatuses 1 and 21 control timing at which the digital video/audio data is exchanged therebetween according to a peer-to-peer system.

What is claimed is:

1. An audio processing apparatus for processing a plurality of pieces of audio data of sounds picked up by a plurality of microphones, the apparatus comprising:
a speaker identification section configured to identify a speaker based on the plurality of pieces of audio data;
a simultaneous speech section identification section configured to, when at least first and second speakers have been identified by said speaker identification section, identify speech sections during which the identified first and second speakers have made speeches, and identify a section during which the first and second speakers have made the speeches at the same time as a simultaneous speech section; and
an arranging section configured to separate audio data of the first speaker and audio data of the second speaker from the simultaneous speech section identified by said simultaneous speech section identification section, and allow the audio data of the first speaker and the audio data of the second speaker to be outputted at mutually different timings.

2. The audio processing apparatus according to claim 1, wherein said arranging section allows the audio data of the first speaker to be outputted significantly on a real-time basis, and subjects the audio data of the second speaker to speech rate conversion to shorten an audio of the audio data of the second speaker along a time axis.

3. The audio processing apparatus according to claim 2, further comprising:
a silent section identification section configured to identify a section during which a sound level is equal to or below a predetermined threshold as a silent section, based on the audio data of the sounds picked up by the microphones, wherein
if the audio data arranged includes the silent section, said arranging section compresses the silent section.

4. An audio processing system for processing a plurality of pieces of audio data of sounds picked up by a plurality of microphones, the system comprising:
a speaker identification section configured to identify a speaker based on the plurality of pieces of audio data;
a simultaneous speech section identification section configured to, when at least first and second speakers have been identified by said speaker identification section, identify speech sections during which the identified first and second speakers have made speeches, and identify a section during which the first and second speakers have made the speeches at the same time as a simultaneous speech section; and
an arranging section configured to separate audio data of the first speaker and audio data of the second speaker from the simultaneous speech section identified by said simultaneous speech section identification section, and allow the audio data of the first speaker and the audio data of the second speaker to be outputted at mutually different timings.

5. An audio processing program for processing a plurality of pieces of audio data of sounds picked up by a plurality of microphones, the program causing a computer to perform:
a speaker identification process of identifying a speaker based on the plurality of pieces of audio data;
a simultaneous speech section identification process of, when at least first and second speakers have been identified by said speaker identification process, identifying speech sections during which the identified first and second speakers have made speeches, and identifying a section during which the first and second speakers have made the speeches at the same time as a simultaneous speech section; and
an arranging process of separating audio data of the first speaker and audio data of the second speaker from the simultaneous speech section identified by said simultaneous speech section identification process, and allowing the audio data of the first speaker and the audio data of the second speaker to be outputted at mutually different timings.

6. An audio processing apparatus for processing a plurality of pieces of audio data of sounds picked up by a plurality of microphones, the apparatus comprising:
speaker identification means for identifying a speaker based on the plurality of pieces of audio data;
simultaneous speech section identification means for, when at least first and second speakers have been identified by said speaker identification section, identifying speech sections during which the identified first and second speakers have made speeches, and identifying a section during which the first and second speakers have made the speeches at the same time as a simultaneous speech section; and
arranging means for separating audio data of the first speaker and audio data of the second speaker from the simultaneous speech section identified by said simultaneous speech section identification section, and allowing the audio data of the first speaker and the audio data of the second speaker to be outputted at mutually different timings.
